(19) United States
(12) Patent Application Publication
(10) Pub. No.: US 2005/0195541 A1
(43) Pub. Date: Sep. 8, 2005

(54) LOAD AND MATCHING CIRCUIT HAVING ELECTRICALLY CONTROLLABLE FREQUENCY RANGE

(76) Inventors: Hsiao-Chin Chen, Hsin-Chu City (TW); Chien-Kuang Lee, Hsin-Chu Hsien (TW)

Correspondence Address: NORTH AMERICA INTERNATIONAL PATENT OFFICE (NAIPC), P.O. BOX 506, MERRIFIELD, VA, 22116, US

(21) Appl. No.: 10/708,463

(22) Filed: Mar. 5, 2004

(51) Int. Cl. H02H 9/00

(52) U.S. Cl. 361/58

(57) ABSTRACT

A first inductor or resistor has a first terminal connected to a first node and a second terminal connected to a supply node or AC ground node. The first node is a first point of connection between a first circuit and a second circuit. A first varactor has a first terminal connected to the first node and a second terminal connected to a control signal. An optional control signal generator generates the control signal according to the C-V curve of the first varactor in order to adjust the capacitance of the first varactor, optimize the energy transfer between the first circuit and the second circuit and also can match the output impedance of the first circuit to the input impedance of the second circuit.

### BACKGROUND OF INVENTION

1. Field of the Invention

The invention relates to a load circuit and a matching circuit, and more particularly, to a load circuit and a matching circuit having an electronically controllable frequency range and a method of optimizing the energy transfer between a first circuit and a second circuit.

2. Description of the Prior Art

FIG. 1 shows a block diagram of a typical receiver front-end 10 of a wireless communication transceiver according to the prior art. An input signal RF_in is amplified by a low noise amplifier (LNA) 11 and then down converted to an intermediate frequency (IF) signal or a baseband frequency signal by a mixer 12, which mixes the amplified input signal RF_in with a local oscillator signal generated by a local oscillator (LO) 14. The operating frequency range of the receiver front-end 10 is limited by the bandwidth of the LNA 11 and a matching circuit coupled between the LNA 11 and the mixer 12. The bandwidth of the LNA 11 is largely dependent on an LNA load 13. The load 13 of the LNA 11 provides the required load impedance for the LNA 11 and also the matching between the LNA 11 and the mixer 12.

FIG. 2 shows a block diagram of a typical transmitter front-end 15 of a wireless communication transceiver according to the prior. A baseband or IF signal is up-converted by a modulator 16 (or an up-converter), which mixes the baseband or IF signal with a local oscillator signal generated by a local oscillator (LO) 20. A pre-amplifier 17 then amplifies the up-converted signal to generate an output signal RF_out. Similar to the receiver front-end 10 shown in FIG. 1, the operating frequency range of the transmitter front-end 15 depends on the bandwidth of the modulator 16 and on the bandwidth of the pre-amplifier 17. In other words, the operating frequency range of the transmitter front-end 15 depends on the modulator load 18 and on the amplifier load 19. Therefore, the load circuit of an RF circuit not only has an effect on the gain and the frequency of the RF circuit, but also has a substantial effect on the operating frequency bandwidth.

FIG. 3 shows a typical load circuit 21 according to the prior art for providing the required load impedance at the operating frequency of a transistor 22. The load circuit 21 includes an inductor 23 and (optionally) a resistor 24 connected in parallel between a supply node VCC and a node A, which is the point of connection between the output of the transistor 22 and a second circuit.

FIG. 4 shows the frequency response of the load circuit 21 shown in FIG. 3. A first curve 30 illustrates a high-Q frequency response resulting from implementing the load circuit 21 without the resistor 24 or with a very high value resistor 24. The high gain G₂ at the center frequency f_{C1} is due to the fact that the load circuit 21 absorbs very little of the signal being transferred from the transistor 22 to the second circuit. This high gain level is present only at the center frequency f_{C1} and quickly drops off with frequencies on either side of the center frequency f_{C1}. Today's wireless devices are normally required to operate at a range of frequencies. It is therefore desirable to have a large range of frequencies having equal gain, also referred to as the operating bandwidth, so that a single wireless transceiver can be used for a wide frequency range. For this reason, the resistor 24 can be used to increase the operating bandwidth of the load circuit 21. In FIG. 4, a second curve 31 illustrates a low-Q frequency response resulting from implementing the load circuit 21 with a lower value resistor 24. The problem with adding a lower value resistor 24 in order to increase the bandwidth is that this causes an increased attenuation of the gain across the frequency response of the load circuit 21. Additionally, even with a resistor 24, the gain of the load circuit 21 over the operating bandwidth is not equal. This causes reduced energy transfer between the transistor 22 and the second circuit.

FIG. 5 shows a first electronically controllable load circuit 40 having an electronically controlled center frequency used to ensure optimal energy transfer between a first circuit and a second circuit at a plurality of operating frequencies according to the prior art. The first controllable load circuit 40 includes N capacitors (C₁ to C_{N}), N switch elements (S₁ to S_{N}), an inductor 41, and (optionally) a resistor 42. A first switch element S₁ and a first capacitor C₁ are connected in series between a supply node VCC and a connection node A, which is the point of connection between the first circuit and the second circuit. The remaining switch elements (S₂ to S_{N}) and capacitors (C₂ to C_{N}) are similarly connected in pairs between the supply node VCC and the connection node A. Each switch element (S₁ to S_{N}) selectively connects its corresponding paired capacitor (C₁ to C_{N}) to the supply node VCC according to a digital control signal (CNTR₁ to CNTR_{N}), respectively. By selectively connecting different capacitors in this plurality of switched capacitors, the center frequency of the load circuit 40 can be controlled and the operating bandwidth of the load circuit 40 can be extended.

FIG. 6 shows the frequency response of the first electronically controllable load circuit 40 shown in FIG. 5. For the switch elements (S₁ to S_{N}), even if only one of the switch elements is turned on, the finite turn on resistance of the switch element adds to the load circuit and effectively degrades the Q value of the load circuit 40. A first curve 50 illustrates a frequency response at a center frequency f_{C1} resulting when the electronically controllable load circuit 40 has the first switch element S₁ turned on. A second curve 51 illustrates a frequency response at a center frequency f_{C2} resulting when the electronically controllable load circuit 40 has the second switch element S₂ turned on. The center frequency of the electronically controllable load circuit 40 continues to move lower in frequency with slightly lower gain as additional switch elements are turned on. An N^{th} curve 52 illustrates a frequency response at a center frequency f_{CN} resulting when the electronically controllable load circuit 40 has the N^{th} switch element S_{N} turned on. When each switch element (S₁ to S_{N}) is turned off, the capacitors (C₁ to C_{N}) are disconnected from the supply node VCC and effectively removed from the load circuit 40. However, a parasitic capacitance associated with the switch elements (S₁ to S_{N}) in the off state continues to influence the load circuit 40. Because this parasitic capacitance is much smaller than the capacitance of the original capacitors (C₁ to C_{N}), the frequency response curve 53 of the load circuit 40 shifts to a new center frequency f_{C}. Additionally, the decreased capacitance and high resistance of the switch element in the off state results in a higher-Q frequency response at the new center frequency f_{C}. These different gains at different frequencies deviate from the ideal situation of a high constant gain over the operating bandwidth of the load circuit 40.

FIG. 7 shows a second electronically controllable load circuit 60 according to the prior art. The second electronically controllable load circuit 60 ensures optimal energy transfer between a first circuit and a second circuit at a plurality of operating frequencies and includes a capacitor 63, a first switch element 64, a resistor 65, a second switch element 66, an inductor 67, and an inverter 68. The first switch element 64 and the capacitor 63 are connected in series between a supply node VCC and a connection node A, which is the point of connection between the first circuit and the second circuit. The first switch element 64 selectively connects the capacitor 63 to the supply node VCC according to the digital control signal CNTR allowing the center frequency of the second load circuit 60 to be controlled. To compensate for the higher-Q frequency response when the first switch element is switched off, the second switch element 66 selectively connects the resistor 65 to the supply node VCC according to the output of the inverter 68, which is an inverted version of the digital control signal CNTR. By using a plurality of switched capacitor and corresponding switched resistor pairs, the operating bandwidth of the load circuit can be extended while maintaining a relatively constant gain for all frequencies.

FIG. 8 shows the frequency response of the second controllable load circuit 60 shown in FIG. 7. A first curve 70 illustrates the frequency response at a center frequency f_{C2} resulting from operating the load circuit 60 with the first switch element 64 turned on and the second switch element 66 turned off. This is similar to the load circuit 40 shown in FIG. 5 with the addition of a slight parasitic capacitance of the second switch element 66 in the off state. When the first switch element 64 is turned off, the second switch element 66 is turned on to add the resistor 65 to the load circuit 60. This compensates for the higher-Q frequency response that would otherwise be seen at the new center frequency f_{C1} allowing the same gain G₁ at the two center frequencies f_{C1}, f_{C2}. Although using a plurality of these switched capacitors and corresponding switched resisters allows a generally flat frequency response over the operating bandwidth, the additional resistance associated with each resistor 65 reduces the gain and results in a non-optimal energy transfer between the first circuit and the second circuit.

### SUMMARY OF INVENTION

It is therefore a primary objective of the claimed invention to provide an electronically controlled load circuit for optimizing the energy transfer between a first circuit and a second circuit, to solve the above-mentioned non-optimal energy transfer problem at a plurality of center frequencies.

According to the claimed invention, an electronically controlled load circuit is disclosed for optimizing the energy transfer between a first circuit and a second circuit. The electronically controlled load circuit comprises: a first inductor or resistor having a first terminal connected to a first node and a second terminal connected to a supply node or an AC ground node, wherein the first node is a first point of connection between the first circuit and the second circuit; and a first varactor having a first terminal connected to the first node and a second terminal connected to a control signal.

Also according to the claimed invention, a method is disclosed for optimizing the energy transfer between a first circuit and a second circuit, the method comprising: providing a first inductor or resistor having a first terminal connected to a first node and a second terminal connected to a supply node or an AC ground node, wherein the first node is a first point of connection between the first circuit and the second circuit; providing a first varactor having a first terminal connected to the first node; and adjusting the capacitance of the first varactor in order to optimize the energy transfer between the first circuit and the second circuit.

Also according to the claimed invention, an electronically controlled impedance matching circuit is disclosed comprising: a first inductor or resistor having a first terminal connected to a first node and a second terminal connected to a supply node or an AC ground node, wherein the first node is a first point of connection between the first circuit and the second circuit; and a first varactor having a first terminal connected to the first node and a second terminal connected to an control signal.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram of a typical receiver front-end of a wireless communication transceiver according to the prior art.

FIG. 2 is a block diagram of a typical transmitter front-end of a wireless communication transceiver according to the prior art.

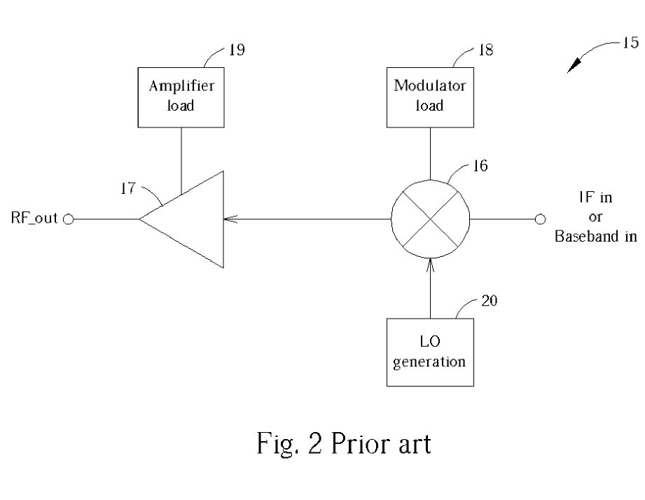

FIG. 3 is a typical load circuit according to the prior art for providing the required load impedance at the operating frequency of a transistor.

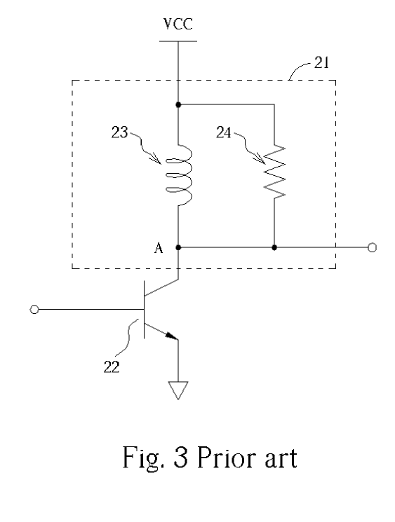

FIG. 4 is a graph showing the frequency response of the load circuit shown in FIG. 3.

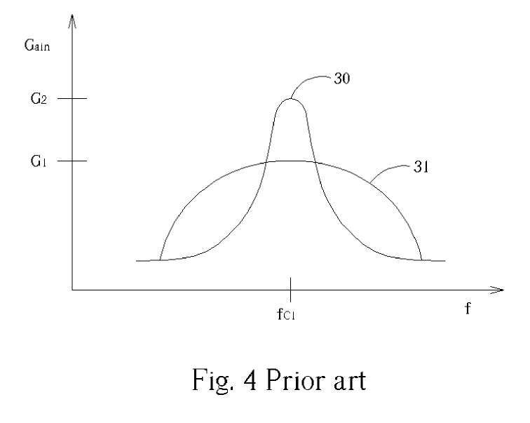

FIG. 5 is a first electronically controllable load circuit having an adjustable center frequency according to the prior art.

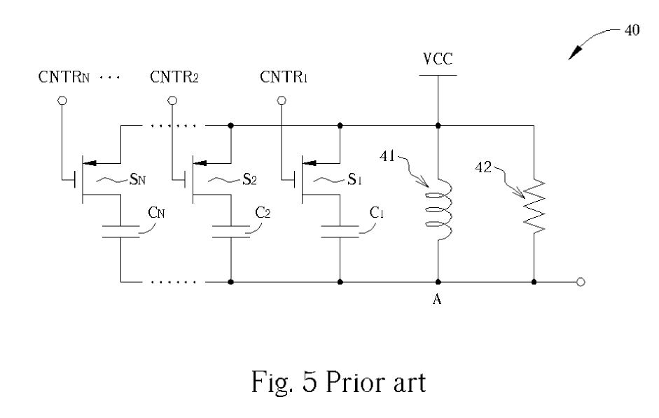

FIG. 6 is a graph showing the frequency response of the first electronically controllable load circuit shown in FIG. 5.

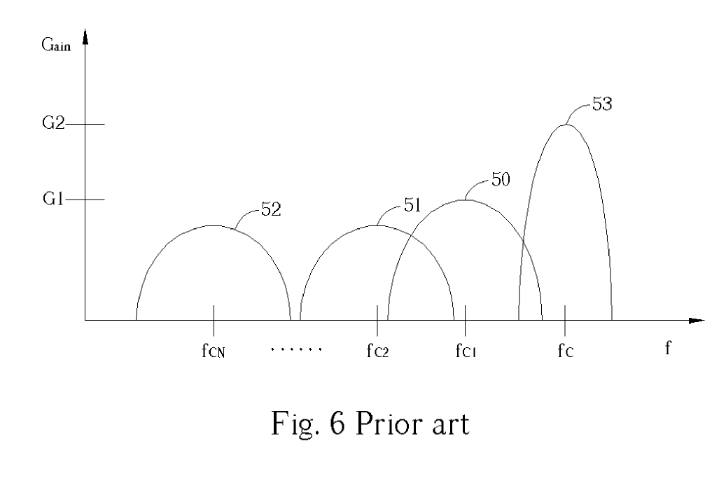

FIG. 7 is a second electronically controllable load circuit according to the prior art.

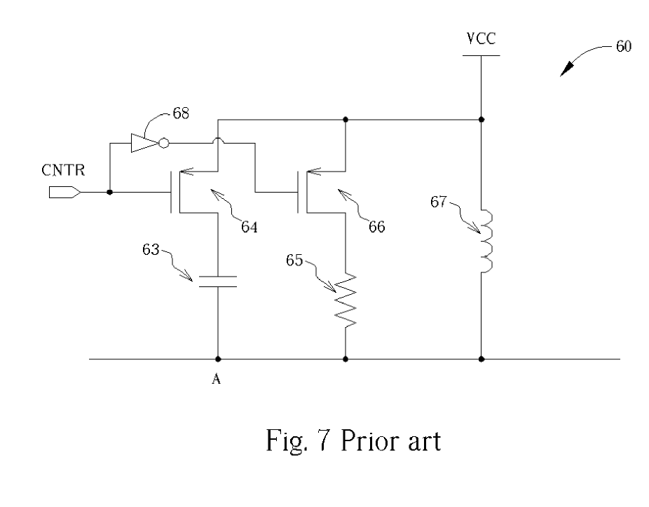

FIG. 8 is a graph showing the frequency response of the second electronically controllable load circuit shown in FIG. 7.

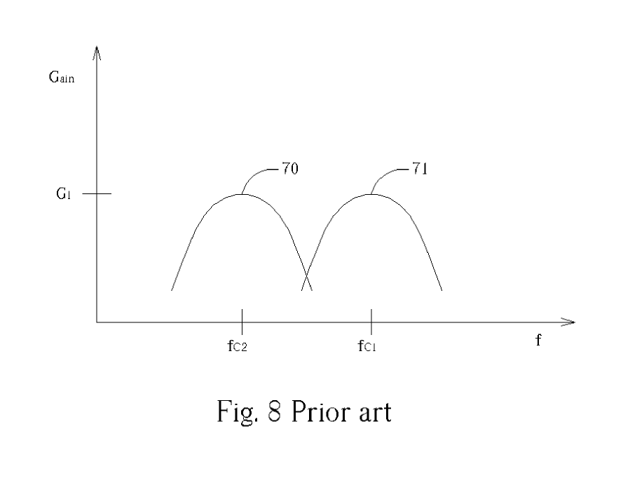

FIG. 9 is an electronically controllable load circuit according to a first embodiment of the present invention.

FIG. 10 is a graph showing the frequency response of the electronically controllable load circuit shown in FIG. 9.

FIG. 11 shows a second electronically controllable load circuit according to a second embodiment of the present invention.

FIG. 12 shows the frequency response of the electronically controllable load circuit shown in FIG. 11.

FIG. 13 is a schematic diagram of the control signal generator shown in FIG. 9.

FIG. 14 is a simplified schematic diagram of a wireless transmitter for direct-up conversion of a differential in-phase input signal and a differential quadrature phase input signal according to a differential version of the first embodiment of the present invention.

### DETAILED DESCRIPTION

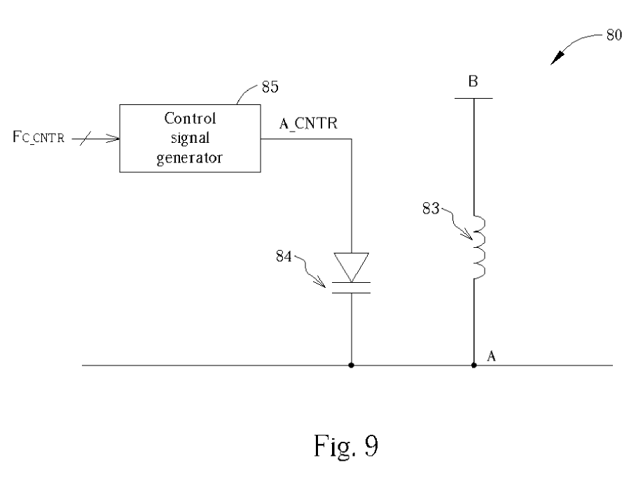

FIG. 9 shows a first electronically controllable load circuit 80 according to a first embodiment of the present invention. The electronically controllable load circuit 80 ensures optimal energy transfer between a first circuit and a second circuit at a plurality of operating frequencies and includes an inductor 83, a varactor 84, and a control signal generator 85. When used as a load circuit, the inductor 83 is connected between a supply node VCC (node B) and a connection node A, which is the point of connection between the first circuit and the second circuit. When used as a matching circuit, the inductor 83 is connected between an AC ground node (node B) and the connection node A. The cathode of the varactor 84 is connected to node A and the anode is connected to a control signal A_CNTR. The control signal generator 85 generates the control signal A_CNTR according to the desired operating frequency F_{C}_{_{—}}_{CNTR} of the load circuit 80. The varactor 84 is operated in the reverse bias mode, and has a capacitance determined by the reverse bias across the varactor 84. The capacitance of the varactor 84 can be changed by varying the control signal A_CNTR. As the control signal A_CNTR varies, the capacitance of the varactor is increased or decreased depending on the characteristic of the varactor. The operating frequency is determined by the combination of the inductor and the capacitance of the varactor. Therefore, the center of the operating frequency is shifted by the variation of the capacitance of the varactor 84. The quality factor Q of a varactor, typically 60˜150, is normally much higher than the inductor Q, typically 8˜18, in the integrated circuit. Due to the high Q characteristic of the varactor, the addition of the varactor does not substantially degrade the overall load Q. In other words, the gain of the amplifier or mixer can be maintained high and flat while switching the center of the operating frequency.

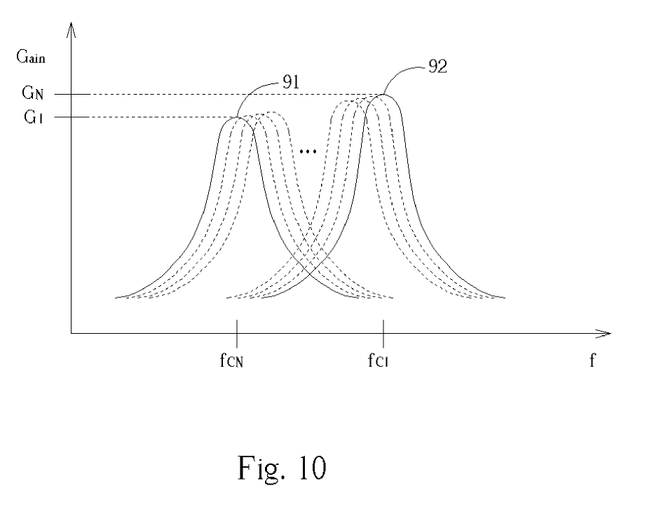

FIG. 10 shows the frequency response of the electronically controllable load circuit 80 shown in FIG. 9. As the capacitance of the varactor 84 decreases, the center frequency increases. As the capacitance of the varactor 84 increases, the center frequency decreases. A first curve 92 illustrates the frequency response at a first center frequency f_{C1}, which is the upper end of the operating bandwidth. An N^{th} curve 91 illustrates the frequency response of the electronically controllable load circuit 80 at an N^{th} center frequency f_{CN}, which is the lower end of the operating bandwidth. Although the Q of the varactor 84 changes with the control voltage, the Q of the varactor is still high enough (compared with the Q of the inductor) over a wide control range. Additionally, as there is no parallel switching resistance associated with the reverse biased varactor 84, the load Q depends largely on the Q of the inductor 83. Therefore, the Q-factor difference between the first center frequency f_{C1} and the N^{th} center frequency f_{CN} is very small, which means the first gain G₁ and the N^{th} gain G_{N} are almost the same. Because the varactor 84 does not degrade the overall load Q, the gain can be maintained high compared with the prior art.

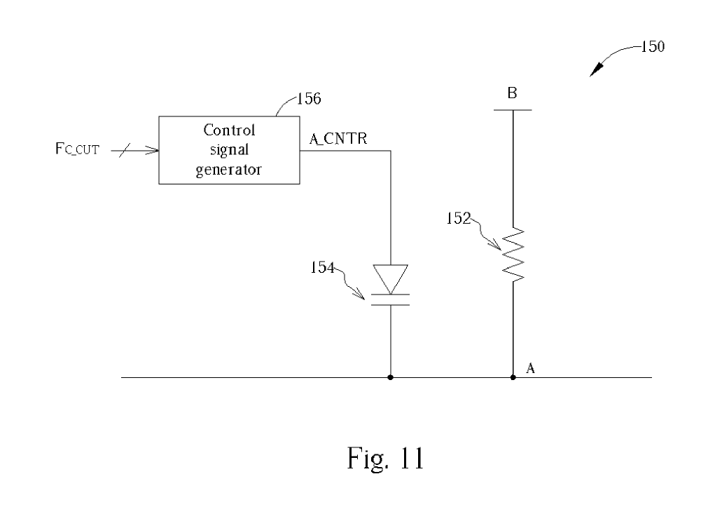

FIG. 11 shows a second electronically controllable load circuit 150 according to a second embodiment of the present invention. The electronically controllable load circuit 150 ensures optimal low pass energy transfer between a first circuit and a second circuit at low frequency bandwidth and includes a resistor 152, a varactor 154, and a control signal generator 156. The resistor 152 is connected between a supply node VCC or an AC ground node (node B) and a connection node A, which is the point of connection between the first circuit and the second circuit. The cathode of the varactor 154 is connected to node A and the anode is connected to a control signal A_CNTR. The control signal generator 156 generates the control signal A_CNTR according to the desired cutoff frequency F_{C}_{_{—}}_{CUT} of the load circuit 150. The varactor 154 is operated in the reverse bias and has a capacitance determined by the reverse bias across the varactor 154. The operating low pass bandwidth of the circuit 150 is determined by the capacitance of the varactor 154. Therefore, the operating bandwidth can be changed by the variation of the capacitance of the varactor 154.

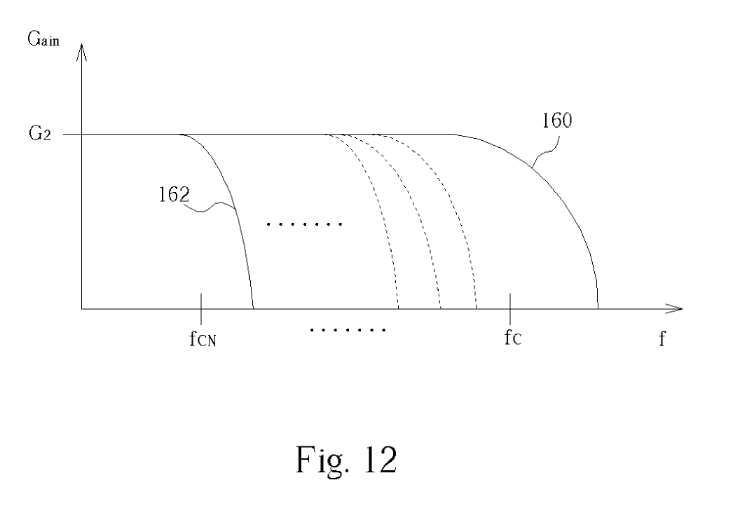

FIG. 12 shows the frequency response of the electronically controllable load circuit 150 shown in FIG. 11. As the capacitance of the varactor 154 increases, the bandwidth of the frequency response decreases. As the capacitance of the varactor 154 decreases, the bandwidth of the frequency response increases. A first curve 160 has a first low-pass cutoff frequency fc, which represents a smaller varactor 154 capacitance and thus a wider frequency bandwidth. An N^{th} curve 162 illustrates the frequency response of the electronically controllable load circuit 150 at an N^{th} cutoff frequency f_{CN} which represents a larger varactor 154 capacitance and thus a smaller frequency bandwidth.

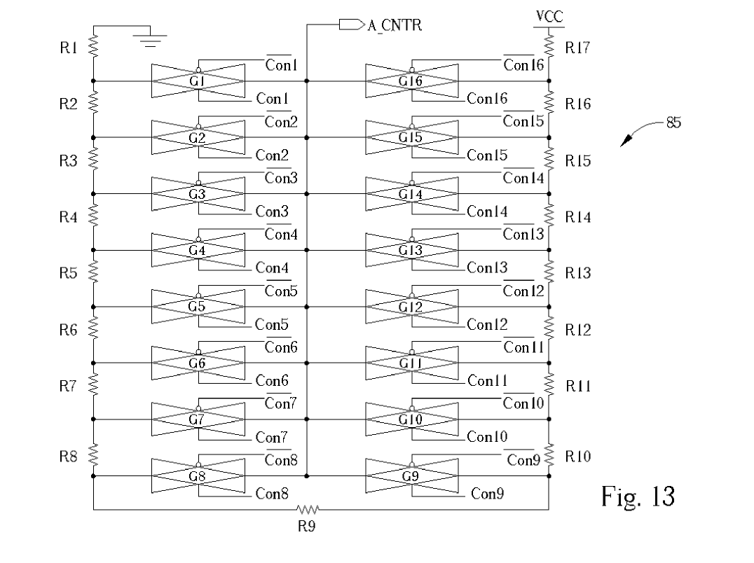

FIG. 13 shows a schematic diagram of the control signal generator 85 shown in FIG. 9. The control signal generator may optionally be required for generating the control signal A_CNTR according to the C-V (capacitance vs. control voltage) curve of the varactor. The control signal can adjust the capacitance of the varactor in order to optimize the load or matching circuit bandwidth. The control signal generator 85 is similar to a digital to analog converter (DAC) and includes a plurality of resistors (R1 to R17) connected in series between the supply node VCC and ground. A plurality of transmission gates (G1 to G16) are connected between the resistors (R1 to R17) and the control signal A_CNTR. The transmission gates (G1 to G16) are controlled by control signals (Con1 to Con16), respectively. This implementation of the control signal generator 85 allows the electronically controllable load circuit 80 to have sixteen different center frequencies. Depending on design requirements, more resistors can be used to allow closer spaced center frequency settings. However, because the capacitance associated with the varactor 84 is not a linear function of the reverse voltage across the varactor 84, as the reverse voltage approaches VCC, the capacitance of the varactor 84 exponentially increases. For this reason, the control signal generator 85 differs from a typical DAC in that the resistors (R1 to R17) have equal decreasing values. To allow equal spacing between the different center frequencies of the load circuit 80, each resistor value may be set different according to the C-V curve of the varactor used. The first center frequency f_{C1}, shown as curve 92 in FIG. 10, is obtained by enabling only the first transmission gate G1. In general, the N^{th} center frequency f_{CN} is obtained by enabling only the N^{TH} transmission gate G_{N}.

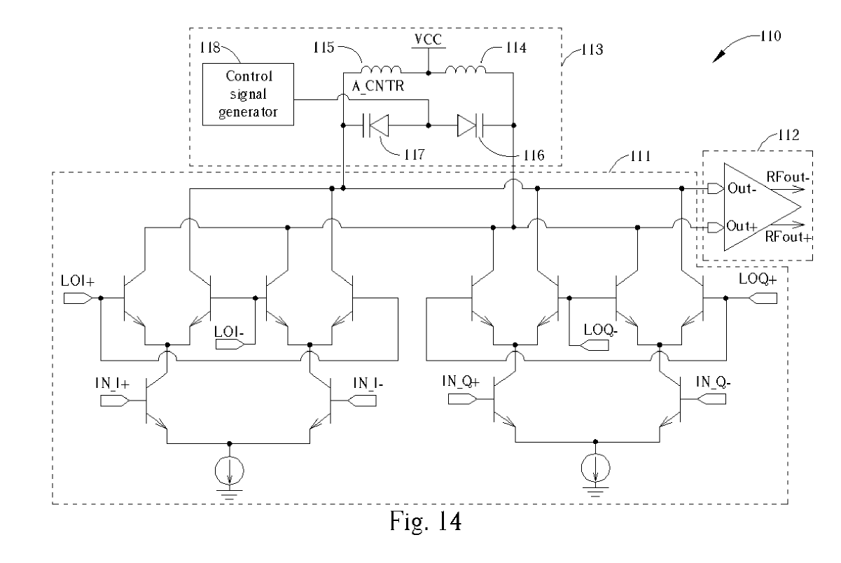

FIG. 14 is a simplified schematic diagram of a wireless transmitter 110 for direct-up conversion of a differential in-phase input signal (IN_I+, IN_I−) and a differential quadrature phase input signal (IN_Q+, IN_Q−) according to a differential version of the first embodiment of the present invention. The wireless transmitter 110 includes a mixer 111, a driver 112, and an electronically controlled load circuit 113. The electronically controlled load circuit 113 in FIG. 14 is a differential implementation and includes a first inductor 114, a second inductor 115, a first varactor 116, a second varactor 117, and a control signal generator 118. As is well known to a person skilled in the art, differential implementations have much greater common-mode noise rejection and are widely used in high-speed integrated circuit environments. The mixer 111 is a Gilbert mixer for mixing a differential in-phase local oscillator signal (LOI+, LOI−) and a differential quadrature phase local oscillator signal (LOQ+, LOQ−) with the differential in-phase input signal (IN_I+, IN_I−) and the differential quadrature phase input signal (IN_Q+, IN_Q−). As Gilbert mixers are well known in the prior art, further description of the operation of the mixer 111 is hereby omitted. Regarding the electronically controlled load circuit 113, it should be noted that the first inductor 114 and the second inductor 115 can also be implemented using a single inductor having a center tap connected to the power supply node VCC.

The differential output of the mixer 111 is connected to both the driver 112 and the electronically controlled load circuit 113. The control signal generator 118 receives a digital control signal specifying the desired center frequency for the load circuit 113 corresponding to the frequency of the in-phase and quadrature local oscillator signals. The control signal A_CNTR generated by the control signal generator 118 reverse biases the first varactor 116 and the second varactor 117 by the appropriate voltage mount to properly set the center frequency of the load circuit 113. When the wireless transmitter 110 changes frequencies, the in-phase and quadrature phase local oscillator signals as well as the digital control signal specifying the desired center frequency for the load circuit 113 are correspondingly updated. The control signal generator 118 adjusts the control signal A_CNTR to properly bias the first varactor 116 and the second varactor 117 and thereby set the center frequency of the load circuit 113 to the new center frequency. In this way, the electronically controlled load circuit 113 optimizes the energy transfer from the mixer 111 to the driver 112 by allowing for a wide operating bandwidth having a high gain.

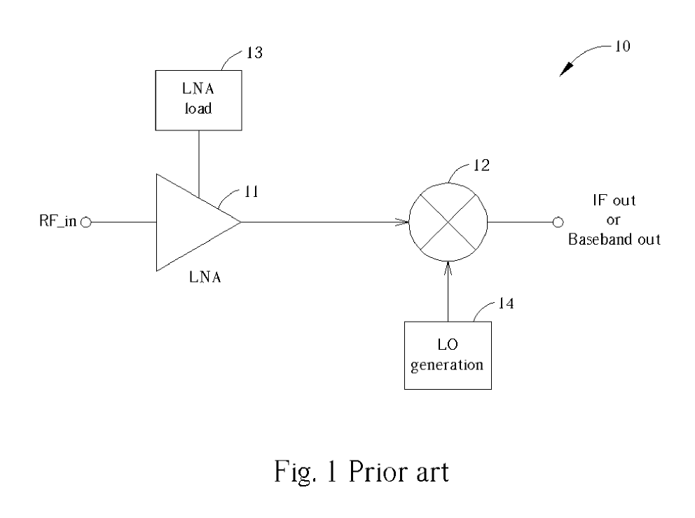

The present invention is not limited to being used in a wireless transmitter and can be used in any circuit to optimize the energy transfer between a first circuit and a second circuit. Additionally, the electronically controlled load circuit according to the present invention can also be used as an electronically controlled impedance matching circuit. For example, by adjusting the control signal A_CNTR, the reflected wave in FIG. 1 that would otherwise be caused by the input impedance of the mixer 13 being different than the output impedance of the LNA 12 is eliminated.

In contrast to the prior art, the present invention optimizes the energy transfer between a first circuit and a second circuit by using a varactor to adjust the capacitance of the load circuit so that a wide operating bandwidth of frequencies all having a high gain is achieved. By adjusting the analog control signal applied to the varactor, the capacitance value associated with the varactor can be directly controlled by the control signal generator. When used in a wireless transmitter, the electronically controlled load circuit according to the present invention provides a higher gain over a wider range of frequencies than the prior art implementation using switched capacitor/switched resistor combinations.

Those skilled in the art will readily observe that numerous modifications and alterations of the device may be made while retaining the teachings of the invention. Accordingly, the above disclosure should be construed as limited only by the metes and bounds of the appended claims.

1. An electronically controlled load circuit for optimizing the energy transfer between a first circuit and a second circuit, the electronically controlled load circuit comprising:
a first inductor or resistor having a first terminal connected to a first node and a second terminal connected to a supply node or an AC ground node, wherein the first node is a first point of connection between the first circuit and the second circuit; and
a first varactor having a first terminal connected to the first node and a second terminal connected to a control signal.

2. The electronically controlled load circuit of claim 1, further comprising a control signal generator for generating the control signal according to a selected center frequency in order to adjust the capacitance of the first varactor and optimize the energy transfer between the first circuit and the second circuit at the selected center frequency.

3. The electronically controlled load circuit of claim 2, further comprising:
a second inductor or resistor having a first terminal connected to a second node and a second terminal connected to the supply node or the AC ground node;
wherein the second node is a second point of connection between the first circuit and the second circuit; and
a second varactor having a first terminal connected to the second node and a second terminal connected to the control signal;
wherein the control signal generator generates the control signal according to the selected center frequency in order to adjust the capacitance of the first varactor and the second varactor and optimize the energy transfer between the first circuit and the second circuit.

4. The electronically controlled load circuit of claim 3, wherein the first inductor or resistor and the second inductor or resistor are formed by a single inductor or resistor having a first terminal connected to the first node, a center tap terminal connected to the supply node or the AC ground node, and a second terminal connected to the second node.

5. The electronically controlled load circuit of claim 2, wherein the control signal generator comprises:
a plurality of resistors connected in series between the supply node and ground; and
a plurality of switch elements connected between the terminals of the resistors and the control signal, each switch element being controlled by at least one bit of a digital control signal representing the selected center frequency and selectively enabling one of the different voltages between the terminals of the resistors to form the control signal according to the selected center frequency.

6. A method for optimizing the energy transfer between a first circuit and a second circuit, the method comprising:
providing a first inductor or resistor having a first terminal connected to a first node and a second terminal connected to a supply node or an AC ground node, wherein the first node is a first point of connection between the first circuit and the second circuit;
providing a first varactor having a first terminal connected to the first node; and
adjusting the capacitance of the first varactor in order to optimize the energy transfer between the first circuit and the second circuit.

7. The method of claim 6, wherein adjusting the capacitance of the first varactor further comprises adjusting the capacitance of the first varactor according to a selected center frequency in order to optimize the energy transfer between the first circuit and the second circuit at the selected center frequency.

8. The method of claim 6, further comprising:
providing a second inductor or resistor having a first terminal connected to a second node and a second terminal connected to the supply node or the AC ground node;
wherein the second node is a second point of connection between the first circuit and the second circuit;
providing a second varactor having a first terminal connected to the second node; and
adjusting the capacitance of the first varactor and the second varactor in order to optimize the energy transfer between the first circuit and the second circuit.

9. The method of claim 8, wherein the first inductor or resistor and the second inductor or resistor are formed by a single inductor or resistor having a first terminal connected to the first node, a center tap terminal connected to the supply node or the AC ground node, and a second terminal connected to the second node.

10. The method of claim 6, wherein adjusting the capacitance of the first varactor comprises:
providing a plurality of different voltages formed by a plurality of resistors connected in series between the supply node and ground; and
selectively connecting one of the different voltages to a second terminal of the first varactor according to the selected center frequency.

11. The method of claim 6, further comprising adjusting the capacitance of the first varactor in order to match an output impedance of the first circuit with an input impedance of the second circuit.

12. An electronically controlled impedance matching circuit comprising:
a first inductor or resistor having a first terminal connected to a first node and a second terminal connected to a supply node or an AC ground node, wherein the first node is a first point of connection between the first circuit and the second circuit; and
a first varactor having a first terminal connected to the first node and a second terminal connected to an control signal.

13. The electronically controlled impedance matching circuit of claim 12, further comprising a control signal generator for generating the control signal according to a selected center frequency in order to adjust the capacitance of the first varactor and optimize the energy transfer between the first circuit and the second circuit at the selected center frequency.

14. The electronically controlled impedance matching circuit of claim 13, further comprising:
a second inductor or resistor having a first terminal connected to a second node and a second terminal connected to the supply node or the AC ground node;
wherein the second node is a second point of connection between the first circuit and the second circuit; and
a second varactor having a first terminal connected to the second node and a second terminal connected to the control signal;
wherein the control signal generator generates the control signal according to the selected center frequency in order to adjust the capacitance of the first varactor and the second varactor and optimize the energy transfer between the first circuit and the second circuit.

15. The electronically controlled impedance matching circuit of claim 14, wherein the first inductor or resistor and the second inductor or resistor are formed by a single inductor or resistor having a first terminal connected to the first node, a center tap terminal connected to the supply node or the AC ground node, and a second terminal connected to the second node.

16. The electronically controlled impedance matching circuit of claim 13, wherein the control signal generator comprises:
a plurality of resistors connected in series between the supply node and ground; and
a plurality of switch elements connected between the terminals of the resistors and the control signal, each switch element being controlled by at least one bit from a digital control signal representing the selected center frequency and selectively enabling one of the different voltages between the terminals of the resistors to form the control signal according to the selected center frequency.
